(19) United States
(12) Patent Application Publication
(10) Pub. No.: US 2003/0163703 A1
(43) Pub. Date: Aug. 28, 2003

(54) Image key security system and method

(76) Inventors: Mark Nelson Robins, Greeley, CO (US); Heather Noel Bean, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/086,388

(22) Filed: Feb. 28, 2002

(51) Int. Cl. H04L 9/00

(52) U.S. Cl. 713/178

(57) ABSTRACT

One embodiment of the present invention provides a system and method for preventing the unauthorized use of property. Briefly described, in architecture, one embodiment of the system comprises an image capture system configured to capture an image of an object and generate data corresponding to the captured image, an image key corresponding to the object, a processor configured to compare the image key with the data corresponding to the captured image, and further configured to enable use of the property only if the data corresponding to the captured image corresponds to the image key, and a security timer configured to time a period of time such that the processor compares the image key with the data corresponding to the captured image after the period of time has elapsed.

### TECHNICAL FIELD

The present invention is generally related to property anti-theft technology and, more particularly, is related to a system and method for preventing the unauthorized use of electronic devices.

### BACKGROUND OF THE INVENTION

Digitally based image capturing devices capture images. The captured image or “photograph” of an object is stored in a digital data format in the memory within, or coupled to, the image capturing device. A nonlimiting example of a digital image capturing device is the digital camera that captures still images and/or video images. As with many types of property, digital cameras are relatively expensive. Digital cameras are thus a target of thieves.

Similarly, many other electronic devices are the targets of thieves. For example, but not limited to, a personal computer (personal computer), a lap top computer or a personal digital assistant (PDA) is a relatively small and easily stolen electronic device. Other types of property, such as, but not limited to, automobiles, boats and airplanes, include electronic components and are subject to theft.

Electronic device owners would benefit from a system and method that would decrease the value of the electronic device in the hands of a thief, while maintaining the value of the electronic device for the owner. For example, physical keys have been used to decrease the value of an electronic device in the hands of a thief who does not possess the key. That is, the electronic device is unusable unless the user is in possession of a valid key.

Such hardware devices are plugged into, or coupled to, the electronic device for the electronic device's software to operate. One example of such a hardware device, or key, is known as a “dongle.” However, a physical key and/or other hardware device may be lost by owners or authorized users and thus result in a loss of value and/or a great inconvenience for the owner since the device cannot be operated without the physical key.

Furthermore, if the property is stolen with the physical key and/or other hardware device, the thief will be able to operate (and presumable sell to another party) the electronic device. Thus, the purpose of the physical key is defeated if the thief also obtains the key.

Thus, a heretofore unaddressed need exists in the industry to address the aforementioned deficiencies and inadequacies.

### SUMMARY OF THE INVENTION

The present invention provides a system and method for preventing the unauthorized use of property. Briefly described, in architecture, one embodiment of the system comprises an image capture system configured to capture an image of an object and generate data corresponding to the captured image, an image key corresponding to the object, a processor configured to compare the image key with the data corresponding to the captured image, and further configured to enable use of the property only if the data corresponding to the captured image corresponds to the image key, and a security timer configured to time a period of time such that the processor compares the image key with the data corresponding to the captured image after the period of time has elapsed.

### BRIEF DESCRIPTION OF THE DRAWINGS

The components in the drawings are not necessarily to scale relative to each other. Like reference numerals designate corresponding parts throughout the several views.

FIG. 1 is a block diagram of selected components of an embodiment of a digital camera, including a memory element storing an image key security system and an image key, and a security timer.

FIG. 2 is a block diagram of selected components of an embodiment of a digital camera, including a memory element storing an image key security system, an image key and a software embodiment of the security timer.

FIG. 3 is a flowchart describing the process of an embodiment of the image key security system of FIGS. 1 and 2.

FIG. 4 is a block diagram of selected components of an alternative embodiment of the image key security system implemented in a digital camera.

### DETAILED DESCRIPTION

The present invention provides a system and method for preventing the unauthorized use of property, such as, but not limited to, an electronic device, a personal computer (personal computer), a digital camera, a lap top computer, a personal digital assistant (PDA), an automobile, a boat or an airplane. The system uses a digital image key 106 created from a captured image of an object.

In one embodiment, the system includes a computer program for comparing a stored digital picture of the object with a current digital picture of the object. In general, the object will be something that is typically in the authorized user's possession. Examples of such objects include, but are not limited to, the authorized user's car key, face, watch, driver's license, finger, and eyeglasses. Any convenient object maybe used that can be compared with image key 106.

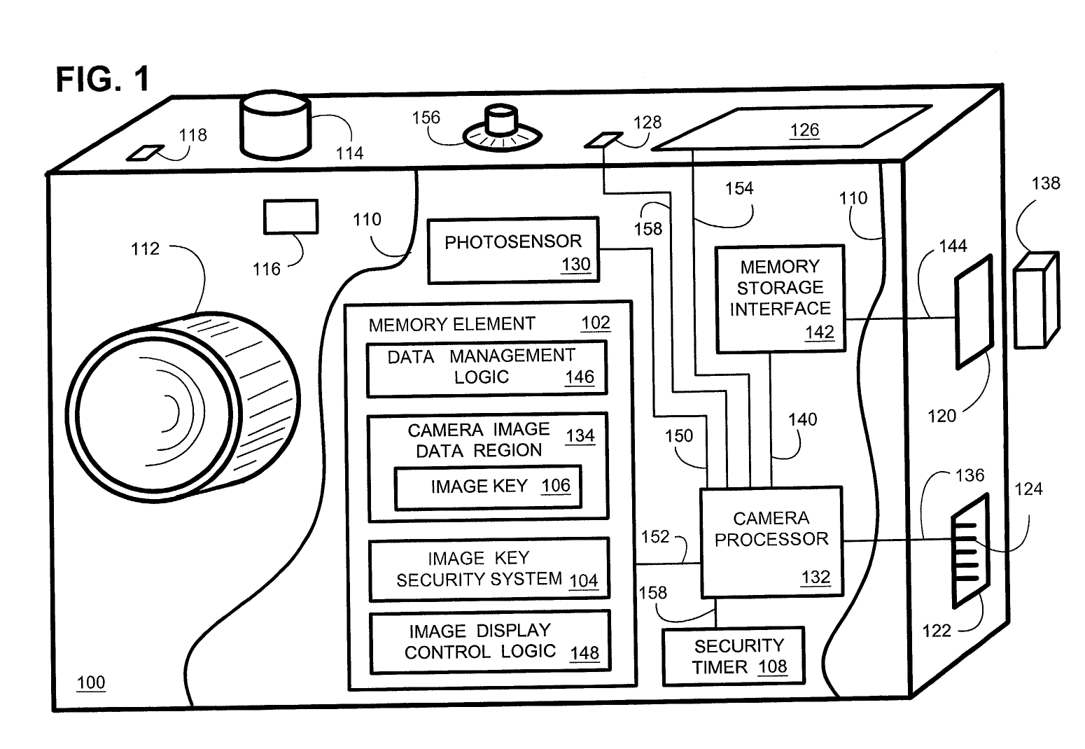

For convenience of teaching the components, operation and functionality of the present invention, the present invention is described as being implemented in, or being a part of, a digital camera 100 (FIG. 1). The present invention is equally applicable in any electronic device configured to detect digital images. For example, but not limited to, a personal computer, lap top computer, or PDA having an image detector are alternative embodiments of the present invention. For example, it is known to include an image detector on or within a personal computer to facilitate video conferencing or to supplement e-mail with picture or video information. Thus, the present invention is incorporated to operate in conjunction with such an image detector.

Furthermore, the present device may be implemented on or incorporated into any other physical device where security is an interest. For example, but not limited to, an automobile, boat, or airplane may be fitted with an image detection device operating in accordance with the present invention. For example, but not limited to, the image key security system 104 may be coupled to an ignition system. Similarly, a door, a gate, a lid, an enclosure or the like can be fitted with an image detection device operating in accordance with the present invention to provide security. For example, but not limited to, the key security system 250 may be coupled to an enclosure locking device.

FIG. 1 is a block diagram of selected components of a digital camera 100, including a memory element 102 storing an image key security system 104, an image key 106, and a security timer 108. FIG. 1 includes selected external and internal components of the digital camera 100, separated by cut-away lines 110. The internal components include a memory element 102 storing an image key security system 104 and data corresponding to a reference image, described in detail below, and referred to hereinafter as an image key 106. The digital camera 100 further may include a lens unit 112, an image capture actuation button 114, a viewing lens 116, a power switch 118, memory unit interface 120 and a plug-in interface unit 122. Plug-in interface unit 122 includes a plurality of connection pins 124. A display 126 is used for previewing images prior to capturing or for viewing captured images. For convenience, the display 126 is illustrated as residing on the top of the digital camera 100.

Operation of the digital camera 100 is initiated by actuation of the power switch 118 or an equivalent device having the same functionality. When digital camera 100 is activated (turned on), the display 126 typically remains off so as to conserve limited battery power of the digital camera 100. As described in greater detail below, actuation of the control button 128, in one embodiment, may turn on the display 126 such that the user (not shown) of the digital camera 100 may view an image detected through the lens unit 112. Alternatively, an image of a previously captured image or a menu screen may be initially displayed. In an alternative embodiment, other buttons, switches or control interface devices are additionally configured to turn on the display screen 124 when actuated.

Lens unit 112 is a well-known device used for the focusing the image on the photosensor 130. When the operator has focused the image to be captured and is satisfied with it, the operator actuates the image capture actuation button 114 (also referred to as a shutter button or a shutter release button) to cause digital camera 100 to record a digital image, thus “photographing” the image. The operator of the digital camera 100 may visually preview the image before capturing the image on display 126 and/or view the image directly through the viewing lens 116. Detailed operation of these above-described individual components of digital camera 100 are not described in detail herein other than to the extent necessary to understand the operation and functioning of these components when employed as part of the system for preventing the unauthorized use of a digital camera.

A personal computer or other processing device (not shown) may be employed with digital cameras such that digital images captured by the digital camera may be retrieved, processed, printed and/or e-mailed. The personal computer or other processing device includes a wire connector interface (not shown) for communicating with digital camera 100 via plug-in interface unit 122. When the user of the digital camera 100 has completed the process of capturing images, the user couples the digital camera 100 to the personal computer by mating a wire connector (not shown) having a plug-in attachment with the plug-in interface unit 122. By providing suitable instructions to the personal computer, other processing device, and/or the camera processor 132, the captured image data is transferred from the camera image data region 134, via connection 136, into the personal computer or other processing device for further processing. Digital image data is transferred from the digital camera 100 to the personal computer or other processing device, via the plug-in interface unit 122, with a suitable wire connector (not shown).

In another embodiment, digital image data is transferred to the personal computer or other processing device using memory module unit 138. When capturing images with digital camera 100, memory module unit 138 is coupled to digital camera 100 through the memory unit interface 120. As the user of digital camera 100 actuates the image capture actuation button 114 to cause the camera processor 132 to save the current image detected by photosensor 130, camera processor 132 transmits the image data via connection 140 to memory storage interface 142. The memory storage interface 142 configures the digital image data for transference to memory module unit 138, via connection 144. In yet another alternative mode of operation, memory storage interface 142 is not included as camera processor 132 directly transmits suitably formatted digital image data to memory module unit 138 via connections 140 and 144 directly.

Digital image data is transferred to the personal computer by removing memory module unit 138 from digital camera 100 and coupling memory module unit 138 to a personal computer memory module interface (not shown). Typically, a convenient coupling port or interface (not shown) is provided on the surface of personal computer or other processing device such that memory module unit 138 is directly coupled to the personal computer. Once memory module unit 138 is coupled to the personal computer memory module interface, digital image data is transferred to the personal computer or other processing device.

Cut-away lines 110 demark components located on the outside surfaces of the digital camera 100 and components located internally in the digital camera 100. Thus, the control button 128, lens unit 112, image capture actuation button 114, power switch 118, memory unit interface 120, plug-in interface unit 122 and display 126 are recognized as components residing on the surfaces of the digital camera 100.

Internal components of the digital camera 100 are illustrated between the two cut-away lines 110. Internal components of the digital camera 100 include at least a camera processor 132, a photosensor 130, a security timer 108 and a memory element 102. Memory element 102 further includes regions allocated for the data management logic 146, the camera image data region 134, the image display control logic 148, and the image key security system 104. Optional elements may also be included, such as the memory storage interface 142.

Photosensor 130 is disposed in a suitable location behind lens unit 112 such that an image (not shown) may be focused onto photosensor 130 for capturing. Photosensor 130 detects an image through lens unit 112 and provides information corresponding to the detected image to the camera processor 132, via connection 150. When digital camera 100 is operating in a mode that displays the image currently detected by photosensor 130 on display 126, via connection 154, hereinafter referred to as the live preview mode, the user of the digital camera 100 can preview a detected current image to determine if the user wants to “photograph” the detected current image. If so, the user of the digital camera 100 actuates the image capture actuation button 114 such that camera processor 132 transfers the received image information from the photosensor 130 into the camera image data region 134 of memory element 102. That is, when the user actuates the image capture actuation button 114, camera processor 132 reformats the current image detected by photosensor 130 into digital image data that is suitable for storage into memory element 102, via connection 152.

In one embodiment, the user creates an image key 106 by actuating image capture actuation button 114 while previewing a detected current image of an object that is generally in the user's possession. The image captured is a reference image that is used to define the image key 106. Data corresponding to the captured reference image is stored in the camera image data region 134 of memory element 102 in one embodiment. Other embodiments store data corresponding to the captured reference image in other locations in memory element 102 or in other suitable memory media, described in greater detail below. For convenience, the data corresponding to the captured reference image is referred to as the image key 106.

The user may be prompted to create image key 106 upon the first use of digital camera 100. Accordingly, when digital camera 100 is first used, the image key security system 104 is not activated. The user captures an image to create the reference image that is used to define image key 106. Subsequent activation of digital camera 100 requires the user to then provide the reference image in accordance with the present invention.

Alternatively, the manufacturer or seller may provide a first reference image that has been used to define a first image key 106. Accordingly, when digital camera 100 is first used, the image key security system 104 requires the user to provide the first reference image in accordance with the present invention. For example, the first reference image may be an object printed on the packaging of the digital camera 100 or an object printed on the operating instructions for the digital camera 100. After the user has successfully activated digital camera 100 in accordance with the present invention using the first reference image, the user selects a personal reference image that is used to redefine image key 106.

One embodiment retains this first image reference and the first image key permanently. Thus, if the later defined image key 106 is corrupted, or if the reference image is no longer available, the user can repeat the above-described process to define a new image key 106.

Also, the user may desire to change the current image key 106 to a new image key 106 from time to time. Thus, the user provides the existing image key 106, and then replaces the existing image key 106 with a new image key 106 in accordance with the present invention.

A security timer 108 is included in one embodiment of digital camera 100 employing an image key security system 104 of the present invention. As described in detail below, security timer 108 clocks or times a predefined period of time. At the end of the predefined time period, image key security system 104 deactivates or otherwise disables digital camera 100 if an image of the reference image has not been captured in accordance with the present invention. Digital camera 100 may be shut off, or limited in its operation so as to effectively render the digital camera 100 unusable for its intended purpose. For example, but not limited to, image key security system 104 may prohibit saving image data in memory element 102 or deactivate selected components of digital camera 100, such that digital camera 100 can not capture images other than an image that is used to compare with image key 106, as described in detail below. Thus, deactivating selected components of digital camera 100 renders digital camera 100 totally or partially inoperable for its intended purpose, and consequently, decreases the value of digital camera 100 such that digital camera 100 is undesirable by a thief.

When the image key security system 104 of the present invention is implemented in property that is configured to detect digital images, similar components described above in digital camera 100 are employed in the property. Thus, at the end of the predefined time as determined by a security timer 108, the image key security system 104 will deactivate or otherwise disable the property or selected components of the electronic device so that the property is unusable for its intended purpose.

One embodiment of the image key security system 104 employs a security timer having a predefined, fixed time period. The predefined, fixed time is specified at the time of manufacture, sale, distribution or at another appropriate time.

One embodiment employs a firmware or a hardware security timer 108 that is configured to time the predefined, fixed time period. When the time period has elapsed, the security timer 108 communicates a signal to a processor residing in the electronic device such that the processor deactivates or otherwise disables the electronic device or selected components of the electronic device. Another embodiment communicates a signal directly to one or more selected components such that the selected component is deactivated or otherwise disabled. For example, such a signal could be communicated to a power supply, a power supply switch, or to a special purpose switch(s) located in the electronic device.

Another embodiment provides for an adjustable time period. The security timer 108 communicates a signal at the conclusion of the timed period, as described above. However, a firmware or hardware embodiment of this security timer 108 employs a memory device configured to receive and store a time period that is adjustable. Thus, the security timer period can be changed with a time adjuster 156. Any suitable memory medium, described below for other components, may be used in such a security timer 108. Furthermore, another embodiment of a security timer 108 may employ a portion of a memory that is used by another component or a multi-purpose memory by simply accessing the appropriate communication busses.

Changing the time period of the security timer 108 may be implemented with a time adjuster 156 in a variety of manners. One embodiment employs a physical device such as a dial, one or more touch-sensitive pushbuttons that increment the time, or a touch sensitive display screen. The time adjuster 156, in one embodiment, is in communication with camera processor 132 or in communication with security timer 108. Another embodiment allows adjustment of the time period through a menu. Such a menu is incorporated into other device operating menus and is controlled by the device's menu selection controllers. The signals corresponding to a time adjustment from the time adjustment device (physical or menu) is communicated to the security timer 108 or to the processor, depending upon the embodiment of the security timer 108 itself.

Yet another embodiment of a security timer 108 is implemented as timer logic software. The software resides in the electronic device's memory. The timer logic is executed by camera processor 132. Time is determined from the processor's clocking system. Such a software embodiment of a security timer may employ either a predefined, fixed time period or an adjustable time period, as described above.

Another embodiment of a security timer 108 employs both a predefined, fixed time period and an adjustable time period. The predefined, fixed time period is used as a default time period. When the adjustable time period is specified, the security timer uses the specified adjustable time period.

For convenience, the image key security system 104 is described as implemented in digital camera 100. Thus, an image key security system 104 employing the security timer is similarly implemented in other electronic devices.

Digital camera 100, in one embodiment, employs a security timer 108 (FIG. 1). For convenience, security timer 108 is illustrated as communicating to camera processor 132, via connection 158. Other embodiments of security timer 108 may be coupled to one or more selected components, as described above.

Security timer 108 detects activation of digital camera 100. Security timer 108 begins timing the time period (fixed or adjustable, as described above). At the end of the time period, if the current digital image of an object that was used to create the image key 106 has not been provided, as described in greater detail below, security timer 108 communicates a signal such that digital camera 100 is deactivated or otherwise disabled. If at the end of the time period, the current digital image of an object that was used to create image key 106 has been provided, as described in greater detail below, digital camera 100 remains enabled.

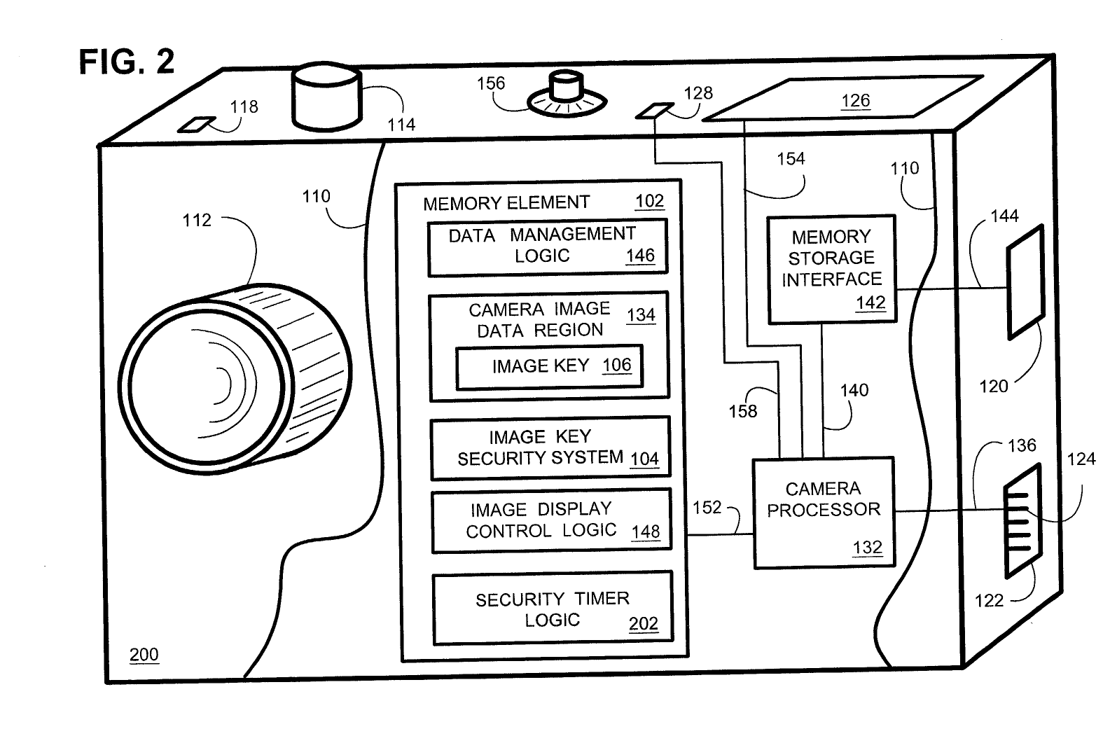

FIG. 2 is a block diagram of selected components of a digital camera 200, including a memory element 102 storing an image key security system 104, an image key 106 and a software embodiment of the security timer logic 202. For convenience of illustration, components in FIG. 2 that are similar to those in FIG. 1 bear the same reference numerals. Such components having the same reference numerals in FIGS. 1 and 2 may be considered to be like elements, however, since these like numeraled elements are similar in operation. However, the components in FIGS. 1 and 2 need not be identical, as any variations of such components will not adversely affect the functioning and performance of the image key security system 104 embodiments. Therefore, the operation and functionality of like elements which are like-numbered will not be described again in detail. Furthermore, some selected components illustrated in FIG. 1 are not illustrated again in FIG. 2 for convenience, but are intended to be included in the digital camera 200.

The embodiment of the image key security system 104 illustrated in FIG. 2 employs a software embodiment of the security timer logic 202, generally described above. Security timer logic 202 is executed by camera processor 132. Camera processor 132 detects activation of digital camera 100. Camera processor 132 then executes security timer logic 202 and begins timing the time period (fixed or adjustable, as described above). At the end of the time period, if the current digital image of an object that was used to create the image key 106 has not been provided, as described in greater detail below, security timer logic 202 communicates a signal such that camera 200 is deactivated or otherwise disabled. If at the end of the time period, the current digital image of an object that was used to create image key 106 has been provided, as described in greater detail below, the camera 200 remains enabled.

Digital cameras 100 and 200 include additional components not shown in FIGS. 1 and 2. Furthermore, the components of digital cameras 100 and 200 described above and illustrated in FIGS. 1 and 2 may reside in other alternative convenient locations. For example, display 126 may be located on the hidden back surface of digital cameras 100 and 200. A time adjuster 156, or another suitable device, described in detail above, is used in one embodiment to adjust the time period timed by the security timer logic 202.

The image key security system 104 of the invention can be implemented in software (e.g., firmware), hardware, or a combination thereof. In the currently contemplated best mode, image key 106 is implemented in software, as an executable program, and is executed by camera processor 132. Camera processor 132 is a hardware device for executing software, particularly that stored in memory element 102. Camera processor 132 can be any custom made or commercially available processor.

Memory element 102 can include any one or combination of volatile memory elements (e.g., random access memory (RAM, such as DRAM, SRAM, SDRAM, etc.) and nonvolatile memory elements (e.g., Flash memory, ROM, hard drive, tape, CDROM, etc.). Moreover, memory element 102 may incorporate electronic, magnetic, optical, and/or other types of storage media. Note that memory element 102 can have a distributed architecture, where various components are situated remote from one another, but can be accessed by camera processor 132.

The software in memory element 102 may include one or more separate programs, each of which comprises an ordered listing of executable instructions for implementing logical functions. In the example of FIG. 1, the software in memory element 102 includes image key security system 104 in accordance with the present invention and data management logic 146. Data management logic 146 controls the execution of other logic, such as image key 106, and provides scheduling, input-output control, file and data management, memory management, and communication control and related services.

The image key 106 may be implemented as a source program, executable program (object code), script, or any other entity comprising a set of instructions to be performed. When implemented as a source program, then the program needs to be translated via a compiler, assembler, interpreter, or the like, which may or may not be included within memory element 102, so as to operate properly in connection with data management logic 146. Furthermore, image key 106 can be written in (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada. In the currently contemplated best mode of practicing the invention, the image key 106 employs the C and/or the C++ programming language.

When digital camera 100 is in operation, camera processor 132 is configured to execute software stored within memory element 102, to communicate data to and from memory element 102, and to generally control operations of digital camera 100 pursuant to image key 106. Image key 106 and data management logic 146, in whole or in part, are read by camera processor 132, and in one embodiment, are buffered within camera processor 132, and then executed.

When image key 106 is implemented in software, it should be noted that the image key 106 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. Image key 106 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic, compact flash card, secure digital card, or the like), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

In an alternative embodiment, where image key security system 104 is implemented as firmware, as hardware or a combination of firmware and hardware, image key security system 104 can be implemented with any or a combination of the following known technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

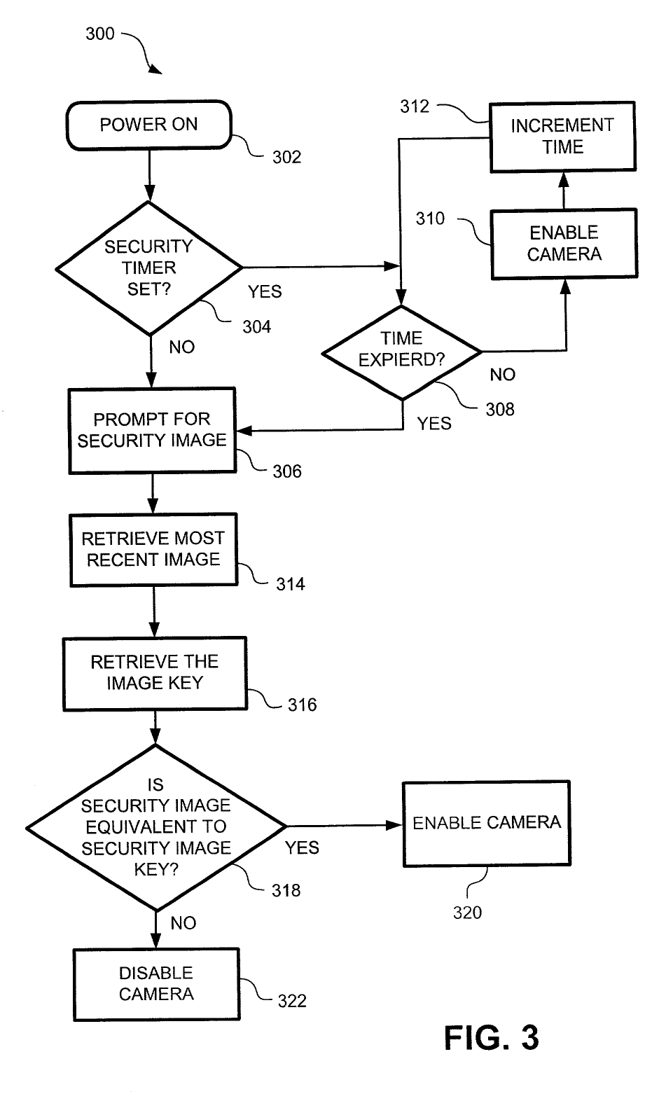

FIG. 3 is a flowchart 300 of a process describing one embodiment of the image key security system 104 of FIGS. 1 and/or 2. Flowchart 300 shows the architecture, functionality, and operation of one implementation of image key 106. In this regard, each block represents a module, segment, or portion of code, which comprises one or more executable instructions for implementing the specified logical function(s). It should also be noted that in some alternative implementations, the functions noted in the blocks may occur out of the order noted in FIG. 3. For example, two blocks shown in succession in FIG. 3 may in fact be executed substantially concurrently or the blocks may sometimes be executed in the reverse order, depending upon the functionality involved, as will be further clarified hereinbelow.

At block 302, image key security system 104 is activated. In one embodiment, image key security system 104 is activated whenever digital cameras 100 or 200 are turned on. Thus, image key security system 104 is activated such that the required image key 106 is provided, as described below, before cameras 100 or 200 can be used, thereby providing the desired security to digital cameras 100 or 200. In another embodiment, digital camera 100 is enabled for a predefined period of time while security timers 108 or 202 are timing the above-described time period.

In another embodiment, the image key security system 104 is activated when a user manually turns on digital cameras 100 or 200. The user may turn on digital cameras 100 or 200 via activation logic 146 associated with data management logic. Then, image key security system 104 is activated automatically upon subsequent activation of cameras 100 or 200. The activation may be via a menu system shown on display 126. The user may turn the system on via a special purpose control button, such as, but not limited to, control button 128. For convenience of illustration, control button 128 is in communication with camera processor 132, via connection 158.

Similarly, image key security system 104 may be deactivated by the user. This embodiment is particularly useful when the user desires to activate or deactivate image key security system 104 at certain times. For example, but not limited to, the user may choose to activate the image key security system 104 when away from the home, and may choose to deactivate image key security system 104 when at home.

In other embodiments, image key security system 104 may be disabled via the owner's personal computer. The personal computer may also have logic for enabling digital cameras 100 or 200 even in the absence of image key 106. This option would allow the digital cameras 100 or 200 to be activated, and a new image key 106 created, in the event of the loss of the object from which the original image key 106 was created.

At block 304, image key security system 104 determines whether a security timer 108 (FIG. 1) or 202 (FIG. 2) has been set. The security timers 108 and 202 may be adjustable by the user by a suitable component, as described above.

If security timer 108 at block 304 is set (the YES condition), the image key security system 104 allows digital camera 100 to operate for a predefined period of time. At the end of the time period, the user is required to capture the reference image. Accordingly, security timer 108 keeps track of this period of time when activated. If the image key security system 104 determines that security timer 108 has not been set, the process proceeds to block 306. That is, if security timer 108 has not been set (the NO condition), digital camera 100 immediately prompts the user for an image of the reference object.

If the image key security system 104 determines security timer 108 has been set (the YES condition), the process proceeds to block 308. At block 308, the image key security system 104 determines whether the time set on security timer 108 has expired. If the time has not expired (the NO condition), the process proceeds to block 310 and enables digital camera 100. Then the process proceeds to block 312 to increment time. The logical loop of blocks 308, 310 and 312 is repeated until the expiration of the time period. Upon expiration of the time period, the process proceeds to block 306. Thus, one embodiment of the image key security system 104 requires the user to capture an image equivalent to image key 106 each time the digital cameras 100 and/or 200 are activated.

At block 306, the image key security system 104 prompts the user to provide a security image. The security image is a current digital image of the object that was used to create image key 106. The object will only be known to the owner and authorized users of digital cameras 100 and 200. At block 314, the image key security system 104 retrieves the most recently captured image from the camera image data region 134. At block 316, image key 106 is retrieved from memory element 102.

Then, at block 318, the image key security system 104 determines whether the most recently captured image is equivalent to, or corresponds to, image key 106. If the image key 106 is equivalent to or corresponds to the most recently captured image (the YES condition), the process proceeds to block 320 and enables digital camera 100. If the image key security system 104 determines the image key 106 is not equivalent to or does not correspond to the most recently captured image (the NO condition), the process proceeds to block 322. At block 322, the image key security system 104 disables the digital camera 100.

Object recognition and image comparison algorithms perform the comparison between the most recently captured image and image key 106. For example, histogram based image classification system and method is employed by one embodiment of image key 106 to determine whether the most recently captured image is equivalent to the image key 106. Other embodiments of the image key 106 employ a genetic algorithm for object recognition method, a model based object recognition method, or a discriminate image recognition method. The above examples of recognition systems employed by embodiments of an image key 106 are merely illustrative embodiments. It is intended that an image key 106 employing other recognition systems and methods are disclosed herein and are protected by the accompanying claims.

If the most recently captured image corresponds to or is equivalent to image key 106, image key security system 104 proceeds to block 320 and enables cameras 100 or 200. If image key security system 104 determines that the most recently captured image does not correspond to or is not equivalent to image key 106, image key security system 104 proceeds to block 318 and disables cameras 100 and/or 200.

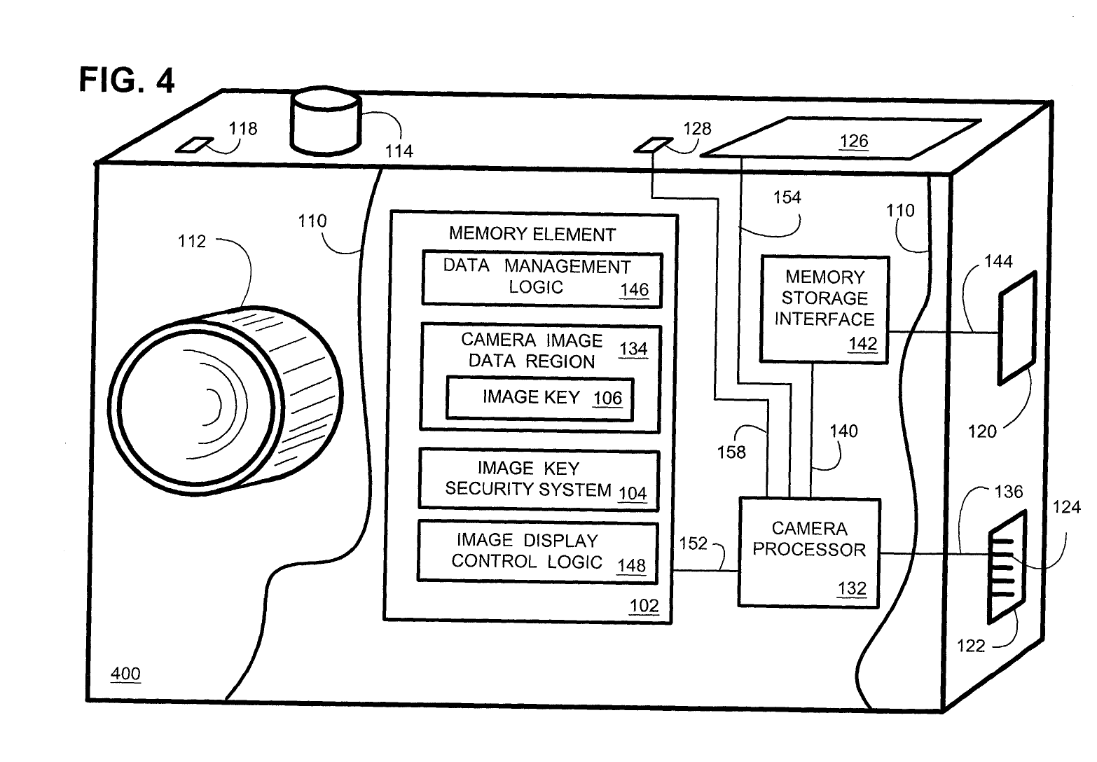

FIG. 4 is a block diagram of selected components of an alternative embodiment of the image key security system 104 implemented in digital camera 400, including a memory element 102 storing an image key security system 104 and an image key 106. Camera 400 does not use a security timer 108 (FIG. 1) or a security timer logic 202 (FIG. 3). Upon activation of camera 400, the first image captured is compared to the image key 106. If the first captured image corresponds to or is equivalent to the image key 106, the image key security system 104 enables the camera 400. If the image key security system 104 determines the first captured image is not equivalent to the image key 106, the image key security system 104 disables the camera 400.

It should be emphasized that the above-described embodiments of the present invention, particularly, any “preferred” embodiments, are merely examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A system for preventing unauthorized use of property, the property comprising:
an image capture system configured to capture an image of an object, and further configured to generate data corresponding to the image of the captured image;
an image key, the image key corresponding to the object;
a processor configured to compare the image key with the data corresponding to the captured image, and further configured to enable use of the property only if the data corresponding to the captured image corresponds to the image key; and
a security timer configured to time a period of time such that the processor compares the image key with the data corresponding to the captured image after the period of time has elapsed.

2. The system of claim 1, wherein the property comprises at least one selected from a group consisting of a digital camera, a personal computer, a laptop computer, a personal digital assistant, an automobile, a boat, an airplane and an enclosure.

3. The system of claim 1, wherein the security timer is a hardware component coupled to the processor and configured to communicate a signal to the processor indicating that the period of time has elapsed.

4. The system of claim 1, further comprising a memory configured to store the security timer as logic such that the processor executes the security timer logic to time the period of time.

5. The system of claim 1, further comprising a time adjuster configured to adjust the period of time timed by the security timer.

6. The system of claim 1, wherein the time adjuster comprises at least one selected from a group consisting of at least one touch-sensitive button, at least one pushbutton, a touch pad display and a menu displayed on a display.

7. A method for providing security to property, the method comprising the steps of:
receiving an image key, the image key corresponding to an image of an object;
receiving a captured image of the object from an image capture device;
timing a time period;
comparing the image key with the captured image of the object; and
enabling use of the property only if the image key corresponds to the captured image of the object.

8. The method of claim 7, further comprising the step of disabling the property when the image key does not correspond to the captured image of the object, wherein the step of disabling the property is performed at the conclusion of the time period.

9. The method of claim 7, wherein the property comprises at least one selected from a group consisting of a digital camera, a personal computer, a laptop computer, a personal digital assistant, an automobile, a boat, an airplane and an enclosure.

10. The method of claim 8, further comprising the steps of:
generating the image key from a second captured image of the object; and
saving the image key in a memory, the steps of generating and saving performed before the steps of receiving, comparing and enabling.

11. The method of claim 7, wherein the step of timing the time period further includes the steps of:
communicating activation of the property to a security timer; and
communicating an end of timing period to a processor such that the processor performs the steps of receiving, comparing and enabling.

12. The method of claim 7, wherein the step of timing a time period further includes the steps of:
executing a security timer logic residing in a memory with a processor; and
beginning the steps of receiving, comparing and enabling when the time period has elapsed.

13. The method of claim 7, further comprising the step of adjusting the time period.

14. A program for preventing the unauthorized use of property, the image key corresponding to a stored digital image of an object, the program being stored as a computer readable medium, the program comprising:
logic configured to retrieve an image key, the image key corresponding to a stored digital image of an object;
logic configured to receive digital data corresponding to a most recently captured image of the object;
logic configured to time a period of time;
logic configured to compare the most recently captured image of the object and the image key; and
logic configured to enable the use of the property only if the most recently captured image of the object corresponds to the image key.

15. The program of claim 14, further comprising logic configured to disable the property if the most recently captured image of the object does not correspond to the image key when the period of time has elapsed.

16. The program of claim 14, further comprising logic configured to time a period of time such that the logic configured to enable is executed when the period of time has elapsed.

17. The program of claim 14, further comprising logic configured to receive a time adjustment communication such that the period of time is adjusted.

18. A method for providing security to property having an image capture device, the method comprising the steps of:
capturing a first image of an object with the image capture device;
generating an image key, the image key corresponding to the first image of the object;
capturing a second image of the object with the image capture device;
comparing the image key with the second image of the object; and
enabling use of the property only if the image key corresponds to the second image of the object.

19. The method of claim 18, further comprising the step of disabling the property when the image key does not correspond to the captured image of the object.

20. The method of claim 18, wherein the property having the image capture device comprises at least one selected from a group consisting of a digital camera, a personal computer, a laptop computer, a personal digital assistant, an automobile, a boat, an airplane and an enclosure.

21. The method of claim 18, further comprising the step of timing a time period such that the steps of comparing and enabling are performed at the conclusion of the time period.

22. The method of claim 21, wherein the step of timing the time period further includes the steps of:
communicating activation of the property to a security timer; and
communicating end of timing period to a processor such that the processor performs the steps of comparing and enabling.

23. The method of claim 21, wherein the step of timing further includes the steps of:
executing a security timer logic residing in a memory with a processor; and
beginning the steps of comparing and enabling when the time period has elapsed.

24. The method of claim 21, further comprising the step of adjusting the time period.
